(19) United States
(12) Patent Application Publication
(10) Pub. No.: US 2008/0228455 A1
(43) Pub. Date: Sep. 18, 2008

(54) Reverse Bioengineering a Vascular tree

(76) Inventor: William Lafayette Mondy, Wesley Chapel, FL (US)

Correspondence Address: William L. Mondy;Adiana Research and Development, 2622 Rosehaven Dr., Wesley Chapel, FL, 33544, US

(21) Appl. No.: 11/856,043

(22) Filed: Sep. 16, 2007

Related U.S. Application Data
(60) Provisional application No. 60/825,901, filed on Sep. 15, 2006.

(51) Int. Cl. G06G 7/48

(52) U.S. Cl. 703/11

(57) ABSTRACT

Success of in vitro vasculogenesis has been limited to structuring relatively small leaky capillary networks and short scaffold-supported vascular-like, tubes that have in some cases, stimulated limited vasculogenesis in vivo. These attempts lacked the structural design millions of years of evolution has established in creating vascular structures. Many mathematical models have taken an approach at computing the anastomosis and patterning found in the vascular branching systems present tissue structures. These attempts at modeling a vascular tree system fall far short in being able to reproduce the structural specificity need for specialized tissue structure such as lung and kidney tissues. I define this vascular tree network as a blood vascular system that includes the capillary bed system, which supplies blood to and from a tissue structure.

By using what I term as reverse bioengineering, vascular trees can be created on scaffolds designed using image data obtained from select in vivo vascular networks. With these reverse bioengineered vascular trees the genesis of tissues reproducing these and other selected tissue structure can be supported.

### CROSS-REFERENCE TO RELATED APPLICATIONS.

William L. Mondy claim's priority to his U.S. provisional patent application Ser. No. 60/825-901, filed Sep. 15^{th}, 2006.

### BACKGROUND OF THE INVENTION

1. Field of the Invention

The invention concern a process for producing three-dimensional computer aided designs

(CAD) of structures engineered to support the reverse engineering of vascular tree systems and other tissue structures. The fabrication of these CAD designs into structures engineered to support the genesis tissues and their precursors from viable cells in or on matrixes and or scaffolds that designed using this process.

2. Background Description

Previous studies of the vascular network found in organs, which under gas or fluid exchange with the external environment has provided a unique view of the three dimension range covered by capillaries, arteries and veins. This visualization of the circulation system role in sustaining large areas of cellular growth, therefore from these studies we derived techniques that enables us to design a method for constructing a replicas of vasculatures for specific tissue regions. The volume flow of blood being pumped from a heart at any given time creates variable forces on the blood vessel walls. The structural properties of blood vessels are regulated by the internal blood forces and external structural supportive forces exerted on them.

With the onset of new discoveries in stem cell development clues are being discovered that will allow in the near future the large scale production of not only stem cells, but all types of cells in a state non-differentiating proliferative state. Techniques are needed that will open pathways to the in-vitro engineering of unlimited types of tissues for transplantation and large womb healing—even the engineering of organs may not be far away. The successful completion such a project will involve utilizing the interdisciplinary transfer of information if not technologies from molecular biology, cellular biology, biochemistry—chemical, material and even electrical engineering.

To present, multilayer three dimensional tissue structures have resisted production. This is due to the inability to provide nutrients and oxygen to cells too far from tissue/culture media surface interface. The diffusion of nutrients metabolic waste and other factors through the extracellular matrix occurs at a rate too slow for cells to survive much further than a few cell layers with out some type of specialization occurring in the cells metabolism or organization. This is the basis of the formation of body cavities and circulatory systems in early metazoans over 600 million years ago. Even today researchers are exploring how chemotactic behavior is initiated through the release and diffusion of certain cellular factors (Solari et al. 2006). The single cellular slime mold Dictyostelium discoideum, when nutrients are used up form colonies to survive. Individual organisms are attracted to the cells releasing the highest levels of CAMP. Single cell Dictyostelium discoideum respond metabolically to CAMP (Bolourani et al. 2006) in using the same signal transduction pathways common to those that signaling endothelial and smooth muscle cells to migrate during vasculogenesis (Nicholl et al. 2004; Takahashi et al. 1996). Specializations make it imperative that the proper environment is supplied to the developing tissues in order to obtain the desired result from cell culturing techniques. In order to bioengineer the large tissue structure a true intercellular circulatory system is a necessity. The key is how do you recreate such an intrinsic design?

3-D prototyping is a very is established field of engineering as given us the ability to bring virtual model and to physical existence. The mathematical models currently being used to create vascular tree models fall extremely short of nature's design (Chong et al. 1999). To solve this problem we use actual image data to illustrate size, dimensions, branching and the other complexities of natural structures. Through reverse engineering principles we create, designs that mimic these natural structures. Thus we coin phrase ‘reverse bioengineering’.

### SUMMARY OF THE INVENTION

This novel design process serves to create the template for vascular scaffolding construction using any number of the 3D laser microfabrication and other 3D prototyping techniques. The scaffolds and other structures formed using this design process will lead to the in vitro biomedical engineering of intact functional vascular networks which include capillary structures needed to make available atoms and molecules necessary for the maintenance, growth and function of three dimensional tissue structures. These bioengineered vessels will enhancement a variety of therapeutic protocols including but not limited to: organ and tissue repair, systemic disease mediation and cell/tissue transplantation therapy. Likewise, our successful approach to in vitro vasculogenesis will make it possible for the bioengineering of various other types of three-dimensional tissue structures greatly expanding the potential application of biomedical engineering technology into the arenas of biomedical research and medicine.

### DETAILED DESCRIPTION OF A PREFERRED EMBODIMENT OF THE INVENTION

Scaffolds have been created for blood vessels but these scaffolds have been used to make large mostly straight tubes of a constant diameter. Not much branching and no complex of small vessels or capillaries of any sort (Sodian et al. 2005).

New methods were needed to develop a bimolecular scaffold that supports a wide array of cellular functions and is not rejected by the host. For nearly twenty years studies of the three dimensional structure of blood vessels (Schraufnagel 1987) and other luminal systems found in the body (Hojo 1993) have produced techniques in that use a blend of vinyl chloride latexes consisting of a plasticized vinyl chloride copolymer with a vinyl chloride copolymer, to create a latex replica of the microvasculature system—demonstrating the luminal surfaces of these structures. Using a cast made from the lumen of the appropriate vascular tree a scaffold can be constructed to replicate that vascular tree's frame work.

The process in claims 1 and 2 will produce models which then can be imported into a bio-CAD program for rendering and refinement. Resulting design can then be imported into 3D laser micro fabrication software and any one of many stereolithography fabrication techniques used to create a scaffold for vasculogenesis. This same process, with modifications in the image selection, can be used to create scaffold designs that model any of cellular tissue structure. Using a single scaffold or by combining scaffolds produced for different cellular produced tissue structures, we have the framework to reverse engineer any of the tissue structures produced in nature.

Extensive literature exist demonstrating techniques for creating a vascular cast that demonstrated the capillary systems for most tissue types. Literature also identifies technique for obtaining images of these microvasculature casts that can be used to reconstruction a digital representation of a 3 dimensional (3D) micro vascular tree.

One technique is computer tomography (CT). Image data obtained using this technique has been used to construct models of various bony tissue structures using 3D prototype fabrication techniques models of and attempts at tissue scaffolding productions (Schipper et al. 2004). NMR data has been similar used to fabricate models of various tissue for scaffolds prototypes (Cheah et al. 2003). These imaging techniques fail to provide the resolution necessary to demonstrate fine tissue structures that exist at the microscopic level. Even micro CT that has resolution around 8 microns can not produce volumetric images of areas large enough to resolve entire vascular tree structures, nor are the capillary systems completely demonstrated.

The 3D reconstruction of serial montages demonstrating capillary pre-capillary anastomosis and other such microscopic tissue structures has been successful at creating models used to understand their structural dynamics (Zhai et al. 2003).

The novelty of process claimed in the patent application is that it combines both of these processes to create image data that represents both the macroscopic and microscopic domains of tissue structures. Then it uses that data for an entirely new concept. The production of bio-CADs that render structures which are design down to the microscopic level to successfully interface with cells such as to support, recruit and influence them to assist in the recreation of naturally designed tissue structures.

In addition this novel process converts these bio-CADs into data files that interface with programs such as Solidworks which drive 3D fabrication and micro patterning equipment creating tissue scaffolds, and or molecular structural pathways that drive and support the genesis of tissue structures like the vascular tree structure of claim 1.

Finally tissue structure created with the processes claimed in this application, such as the vascular tree system—reverse bioengineered complete from large a artery replicating in vivo branching patterns demonstrated image data, down through capillary beds and back up again to large vein—can serve as support structures for further tissue genesis in bedchambers that regulate vascular flow and media content using sensors that generate an feed back data to a computer capable of regulating the dispensing of molecular and environmental factors that control cell behaviors such as migration proliferation differentiation and chemical production.

A cast of the vascular tree's lumen can serve as the perfect subject to provide the frame work on necessary data. This data can provide information concerning sizes and dimensions that will allow us to create a scaffold capably of establishing a new tissue construct that mimic the structure of the original vascular tree. Specific concerns are given to the capillary beds that are vital for molecular exchange in and between cells living around these structures. Combined they are the basis of the 3 dimensional tissue growth and necessary for organ and limb development.

Using a cast made from the lumen of the appropriate vascular tree a scaffold can be constructed to replicate that vascular tree's frame work.

The vascular tree scaffold described above can be constructed on a scaffold of its own. Vascular tree will be perfused with heparinized Ringers solution. Latex or similar resin perfused into MCA and subsequently polymerized in its lumen will serves as the subject for a computer assisted design (CAD) model.

Note:
Capillary bed cast is very fragile and very difficult to scan in 3 dimensions
Alternatively we can use Micro CT to obtain image data without removing tissue, which protects the capillary beds.

For vascular scaffold constructed in this method the selected material must begin as a viscosity liquid and polymerize into a porous, fibrous, biocompatible network similar to successful scaffold previously described. It must allow various degrees of layering, permit cell migration, contain the necessary growth factors found in extra cellular matrix of developing blood vessels (van Meeteren, Ruurs et al. 2006), and be suitable for the engineering of an in-vitro cellular replica of the vascular tree.

The erosion cast is very fragile making the capillary networks extremely hard to maintain intact when handling the structure. The subsequent 3-D image scanning technique presented takes great care.

### Alternative to Erosion Cast Preparation

Using Micro CT capture and reconstruct in 3 dimensions images of a compound called MICROFIL (Flow Tech, Inc. Carver, Mass.) used to fill and opacify the microvascular system.

Capture Images of the Vascular Tree Lumen Cast that are Capable of Being Reconstructed into a Digital 3D Image of the Cast

Image acquisition is needed for gathering data for the production of a bio-CAD model reconstructing of the corresponding vascular tree lumen in 3-D.

An entire vascular tree lumen system excluding capillary systems is imaged in 3D using micro CT scans and the data captured for 3D rendering. Reverse bioengineering calls for the creation of a bio CAD rendering of a sound vascular tree system, data representative of the entire vascular tree system, including the natural capillary bed's structural design. This way we precisely measure and recreate completely the structural dimensions of the biological systems making its functionality under its natural fluid flow condition possible.

Resolution and scanning limitations of micro CT prevented us from directly obtaining all of the image data to capture the complete vascular tree structure from one micro CT scan and subsequent image reconstruction.

### Limitations in the Size of the Area Scanable by Micro CT

The area that can be imaged and reconstructed by Micro CT is limited in size when high resolution instrumentation is used. This makes the area possible to scan smaller than most than the area of most complete vascular tree systems. With Micro-CT results demonstrating the lack of resolving capabilities needed to clearly image the 7 to 10 p diameter tubes that make up the capillary beds of vascular tree system. The resolution limitations of micro computer assisted tomography imaging systems make capturing complete image data for the capillary bed of a vascular tree very difficult to almost impossible, even with the latest equipment. In the future we will be able expect to have improved CT capabilities. But for now, in order to reverse engineer a vasculature tree using micro CT image data, image data for capillary networks missing because resolution limitations is supplied by other means.

We use image data obtained through the reconstruction of serial sections obtained to histological techniques, taken through a reference plane created during tomography scans. Reference points are created in scanned tissue and that correspond with section tissues. The resulting images are imported into bio-CAD software where the afferent and efferent arterioles and veinuoles mesh structures obtained with Micro CT are connected with mess structures obtained through the reconstruction of serial tissue sections from the capillary bed systems.

### Create a Digital 3D Model of the Vascular Tree Lumen Using Computer Assisted Design Techniques and Using Bio-CAD, Designing on Top of Lumen Model a Tissue Scaffold

Image data from Micro CT and re-constituted serial tissue sections are converted to 3D wire frame models and merged together using CAD software. The reconstructed image data sets from Micro-CT and serial section of the corresponding capillary bed are combined to complete the frame work for the bio-CAD model. This frame work gives us a complete 3-D layout of the inner wall of the vascular tree system of interests. Using histological data on vascular wall thicknesses along the length of it structure, AutoCAD can be use to render on top of the layout for the lumen wall a design for a structural scaffolding structured for the seeding of migrating progenitor and or stem cells.

Designs can then be imported into 3-D prototyping software for structures creation. Limitations are found in the creation of microstructures. These limitations are due to the molecular structure of structural materials, the prototyping technology which is fast improving and in the details of the design. By using actual image data obtained directly from vascular tree systems we create a highly detailed model of its structure. Such models are extremely valuable in the 3-D fabrication of scaffold to been used for the tissue engineering of complete vascular tree systems.

Our process of combining a micro computer tomography study of vascular tissue with the reconstruction of thin serial tissue section through capillary beds we keep as a trade secret. The resulting bio-CAD rendering produces a structural design for scaffolding on which a vascular tree can be constructed. The antigenicity of bioengineered vascular tree is reduced by using biocompatible material for scaffolding and by seeding genetically altered undifferentiated cells, such as b-2 immunoglobulin deficient embryonic stem cells (ESC), into scaffolds.

1. Vascular scaffolding designed and fabricated directly from 3D image data of an in vivo occurring vascular network that includes the capillary systems which are necessary to feed the surrounding tissues.

2. The use of image data/information taken from tissue structures to create computer assisted designs of these structures modeled to create a structural framework, both physically and biochemical for tissue genesis of the original structure—built around vascular tree systems formed in accordance with process in claim 1.

3. Incorporating into these designs factors that are responsible for simulating optimal cellular and sub-cellular responses that mediate both normal and abnormal cell behaviors.

4. The use of computer assisted biological designs (CAD) created in accordance with processes in claims 1, and 2, for use with any three dimensional fabrication techniques to create structures that support tissue/organ genesis. This including but not limited to the use of photon laser techniques in the micro patterning of the molecular structures of materials such as hydrogels, to create structural environments that regulate cell behavior and cell functions and patterning their locations to correspond with the with the design specification process in according with claims 2 and 3.

5. The use of vascular trees or any other tissue structure fabricated by a process that is in accordance with any of the claims 1, 2, 3, 4, in this application for the bioengineering of a tissue structure.

6. Use a process in accordance with claim 4 to alter structure of polymer such as photosensitive polymers, that are placed into a body cavity and or wound—and or a surgically created space—in patterns consistent with CAD models created by processes in accordance with claims 2 and 3,—that outline the natural vascular tree structure or other tissue structures such as alveolar sacks or nerve tracts, using any of the 3D laser/2 or 3 photon laser/ techniques.

7. Any CAD created using 3D image data of biological tissues for the creation of scaffolding or other support structures for tissue engineering purposes in accordance with processes in claims 1, 2, 3, 4, 5, and or 6, or for the creation of computer programs that aid in the design and manufacturing of structures to be used in tissue engineering processes.

8. In accordance with the process in claim 8, in order to improve the performance of in-vitro developed blood vascular trees designed in accordance with the process in claim 1, and tissue structures subsequently developed with the assistance process in claim 1 in accordance to the process in claim 5, the to novel equipment described here that is designed to specifically aid the structures formed by all claimed novel design processes. Constructed to provide fluid through and around the vascular tree system of claim 1 programmed to monitor and regulate the responses of tissues created in accordance with any or all processes claims 1, 2, 3, 4, and 5, to assist process in claim 5 to successfully form 3 dimensional tissue structures.

9. Injectable polymers, in accordance with process in claim 6. Photosensitive polymers are alters in 3D patterns reflecting bio-CAD driven program design after natural vascular tree in accordance to processes in claim 1, 2, and or 3. Alterations are made using computer driven 2 or 3 photon lasers, which alter the molecular structure of polymers in areas that produce the cellular responses such as migration or lack of cell penetration, that in essence outline the structural design formed in bio-CAD based on the original image data. This process can be tailored to house and release factors responsible for the cells' morphogenesis into tunic layers comprising the vessel wall or other structures. Factors can control production and or the release of growth factors, chemokines, and regulate migration, proliferation and differentiation of the seeded progenitor cells.
